(19) United States
(12) Patent Application Publication
(10) Pub. No.: US 2014/0032363 A1
(43) Pub. Date: Jan. 30, 2014

(54) METHODS AND SYSTEMS TO PROVIDE INTERACTIVE MARKETPLACE WITH TIME-LIMITED NEGOTIATION

(71) Applicants: Peng Zhao, San Jose, CA (US); Jennifer Ihrie, Los Altos, CA (US); Kevin Carvalho, Sunnyvale, CA (US); Amy Poon, Pleasanton, CA (US); Qian Liu, San Jose, CA (US)

(72) Inventors: Peng Zhao, San Jose, CA (US); Jennifer Ihrie, Los Altos, CA (US); Kevin Carvalho, Sunnyvale, CA (US); Amy Poon, Pleasanton, CA (US); Qian Liu, San Jose, CA (US)

(73) Assignee: eBay Inc., San Jose, CA (US)

(21) Appl. No.: 13/652,053

(22) Filed: Oct. 15, 2012

Related U.S. Application Data
(60) Provisional application No. 61/675,960, filed on Jul. 26, 2012.

(51) Int. Cl. G06Q 30/06

(52) U.S. Cl. 705/26.25

(57) ABSTRACT

Systems and methods to provide a live video-based marketplace negotiation platform in the context of time limited online trading and commerce is described. Embodiments may include an interactive market place where transactions may be negotiated between buyers and sellers in a secure and entertaining manner. In an example, an online trading platform may match potential sellers and buyers based on any of a variety of criteria, and allow sellers and buyers to negotiate a deal in a limited time frame. Negotiations may be performed in real-time over a text, voice, or video communication interface that may include descriptions, images, or videos of a product offered by a seller.

### CLAIM OF PRIORITY

This patent application claims the benefit of priority, under 35 U.S.C. §119(e) to U.S. Provisional Patent Application Ser. No. 61/675,960, titled “METHODS AND SYSTEMS TO PROVIDE INTERACTIVE MARKETPLACE WITH TIME-LIMITED NEGOTIATION” filed on Jul. 26, 2012, which is incorporated herein by reference in its entirety.

### TECHNICAL FIELD

This application pertains generally, but not by way of limitation, to the technical fields of software and/or hardware technology and, in one example embodiment, to systems and methods to provide video-based marketplace negotiation.

### BACKGROUND

Online auction and sales platforms allow users or buyers to shop for almost anything using a web browser application. A user may find an item listed by an online merchant or seller by entering keywords into the search box provided on an associated web page or by browsing through the list of categories on the home page. The results of a search of seller offerings are presented to the user on a search results page. Potential buyers may select items that match their interest and price range.

### OVERVIEW

The present inventors have recognized, among other things, that a problem to be solved can include engaging online users in an interactive market place where transactions may be negotiated between buyers and sellers in a secure and entertaining manner. In an example, the present subject matter can provide a solution to this problem, such as by providing an online trading platform to match potential sellers and buyers and allow a seller and buyer to negotiate a deal in a limited time frame.

This overview is intended to provide an overview of subject matter of the present patent application. It is not intended to provide an exclusive or exhaustive explanation. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates a network diagram, according to an example embodiment.

FIG. 2 illustrates an example seller interface, according to an example embodiment.

FIG. 3 illustrates a four-person auction interface, according to an example embodiment.

FIG. 4 illustrates an example buyer interface, according to an example embodiment.

FIG. 5 illustrates an example targeting interface, according to an example embodiment.

FIGS. 6a through 6d illustrate example interfaces on a mobile device, according to an example embodiment.

FIGS. 7a and 7b illustrate example video interfaces on a mobile device, according to an example embodiment.

FIGS. 8a and 8b illustrate an example transaction completion notifications on a mobile device, according to an example embodiment.

FIG. 9 illustrates an example flow diagram depicting a scheme for an interactive marketplace, according to an example embodiment.

FIG. 10 illustrates an example machine for use with any of the depicted example embodiments.

### DETAILED DESCRIPTION

A method and system to provide a live video-based marketplace negotiation platform in the context of time limited online trading is described. In the following description, for purposes of explanation, numerous specific details are set forth in order to provide a thorough understanding of an embodiment of the present invention. It will be evident, however, to one skilled in the art that the present invention may be practiced without these specific details.

Embodiments of interactive marketplaces include approaches that match potential buyers and sellers via an interactive interface that is provided to a machine of each of the buyer and seller where transactions may be negotiated. In an example embodiment, when a potential buyer types in a query at the buyer's machine, the backend system, which may be referred to as a matching module, calls a search system that may be provided by an online trading platform to find potential sellers of the query subject, and then creates an interactive environment where the buyer and seller may negotiate a deal. The interactive environment presents the buyer and the seller to each other, along with any relevant information provided by the seller when he or she listed an item (e.g., picture, price and title or description of the item).

In an example, the matching module may be configured to receive information from a seller, over a computer network, with the information including an item for sale; and also receive information from a buyer, over a computer network, with the information including a desired purchase. The matching module may review multiple buyers and sellers and match at least one of the sellers to at least one of the potential buyers.

Once the buyer and seller are matched, an interactive selling or buying interface may be provided to the machines of each of the buyer and seller, respectively. The communication through the interactive interface between the buyer and seller may be limited to a predetermined time period. For example, the interactive interface may limit communication between the buyer and seller to a period of time no greater than five minutes. Other shorter and longer time periods are also contemplated. For example, a negotiation period between a matched buyer and seller may be limited to no more than thirty seconds.

In an example, the predetermined time period is less than two minutes. In another example, the predetermined time period is less than four minutes. In a further example, the predetermined time period is received from the seller. The seller may be limited to presenting a fixed number of items to the matched buyer. For example, the seller may be limited to presenting no more than two or three items. In still another example, the seller may be limited to presenting no more than ten items.

In some embodiments, the interactive interface may allow the buyer or the seller to extend the time period allotted for negotiations. The number of times that the buyer or the seller may extend the negotiation session may also be limited. At any point, either the matched buyer or the matched seller may terminate a negotiation session and be matched with another prospective seller or prospective buyer.

A payment module may facilitate completion of a sale between the matched buyer and seller upon receipt of an indication from the buyer that the buyer is willing to sell and an indication from the seller of an offered price. A seller may be allowed to set a desire selling price that can automatically begin a sale transaction if the selling price is accepted by a matched buyer.

In an example, an interactive interface presents a frame in which the buyer may view the seller in real time and the seller may view the buyer in real time using a camera. The frame may be established through a network utilizing a camera mounted in a computer, laptop, or smart phone that includes video and audio capabilities. For example, the seller's interface may allow the seller to configure the seller's web camera to show the seller to a matched buyer. Similarly, a buyer may allow the seller to view the buyer by allowing the buyer's interactive interface to access the buyer's web camera.

The interactive interface may present the seller with an option to end communication with the matched buyer and receive a second match with another potential buyer at any time. The interactive interface may present the buyer with an option to end communication with the matched seller and receive a second match with another potential seller.

Accordingly, one or more of the methodologies discussed herein may obviate a need for computationally intensive centralized processing, which may have the technical effect of reducing computing resources used by one or more devices within the system. Examples of such computing resources include, without limitation, processor cycles, network traffic, memory usage, storage space, and power consumption.

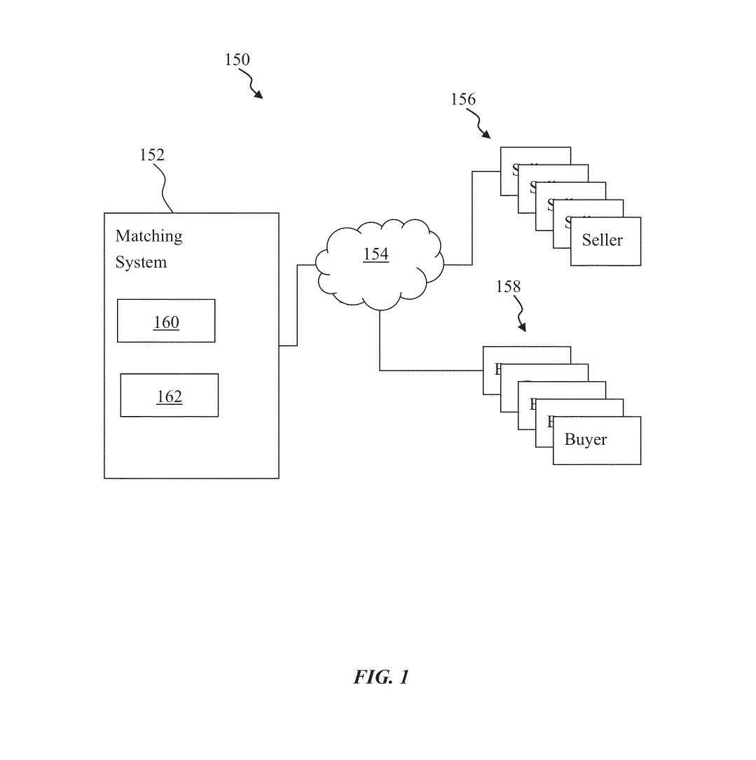

An example method and system to perform potential buyer-seller matching and to provide an interactive interface may be implemented in the context of a network environment 150 illustrated in FIG. 1 below.

FIG. 1 is a network diagram depicting a network environment 150, within which an example embodiment may be deployed. A networked matching system 152, in the example forms of a network-based marketplace or publication system, provides server-side functionality, via a network 154 (e.g., the Internet or Wide Area Network (WAN)) to one or more clients who may be either buyers or sellers. FIG. 1 illustrates, for example, multiple sellers 156 connecting with the matching system 152, for example through a mobile or desktop Web browser operating on the seller's client machine (e.g., a mobile or desktop device), and multiple potential buyers 158 connecting with the matching system 152 through a client machine accessed by the potential buyers.

A payment application 162 may provide a number of payment services and functions to users. The payment application 162 may allow users to conduct transactions as buyers or sellers of products (e.g., goods or services) that are made available by other users. A marketplace application 160 may provide an index or query interface to active buyers or sellers. While the marketplace and payment applications 160 and 162 are shown in FIG. 1 to both form part of the networked matching system 152, it will be appreciated that, in alternative embodiments, the payment applications 162 may form part of a payment service that is separate and distinct from the networked matching system 152.

Further, while the environment 150 shown in FIG. 1 employs client-server architecture, the subject matter of the application is, of course, not limited to such an architecture, and could equally well find application in a distributed, or peer-to-peer, architecture system, for example. The various marketplace and payment applications 160 and 162 could also be implemented as standalone software programs, which do not necessarily have networking capabilities. In a standalone example, a buyer and seller may each interact with an interface module at a local device. The interface module may utilize the networking capabilities of the local device to connect to remote devices and negotiate potential matches, payment transactions, and negotiation communications.

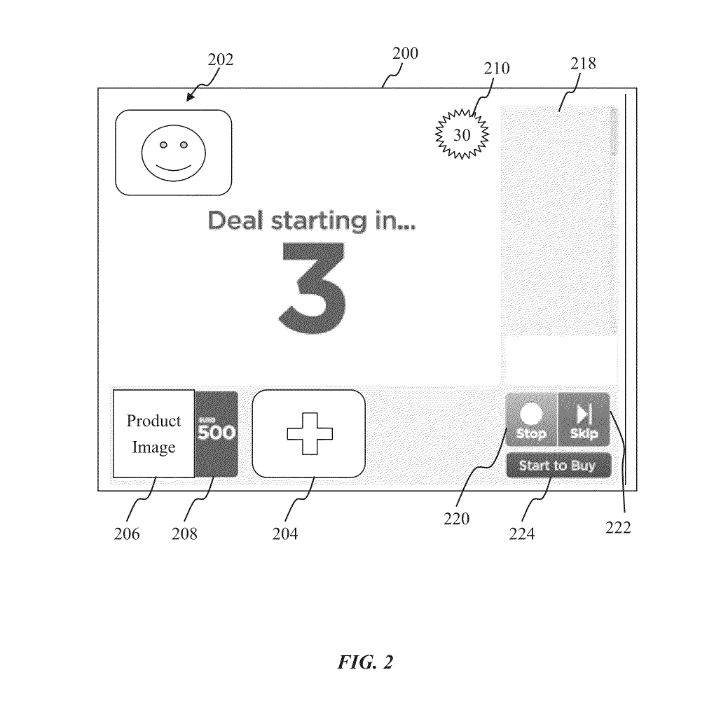

FIG. 2 illustrates an example seller interface 200. The seller may configure a camera to present a still or live image of the seller 202. The interface 200 may include an add button 204 that allows a user to list an item for sate. Items the user has already added may be presented with an image 206 and a desired sale amount 208 for the product being offered by the seller. The seller may upload an image from his or her computer or take a picture of the item for sale with a built-in camera or smart phone.

The interface may include a countdown timer 210 that indicates to the seller the number of seconds remaining to negotiate a deal with a potential buyer. Once a seller is matched with a potential buyer they may communicate through an audio interface associated with the image of the seller 202, or utilize a chat interface 218. The interface may include a stop button 220 that allows the seller to stop selling at any time. A skip option 222 can be selected to advance to a new buyer after receiving an undesired buyer match.

The seller may switch from a selling-mode to a buying-mode by selecting a start to buy option 224.

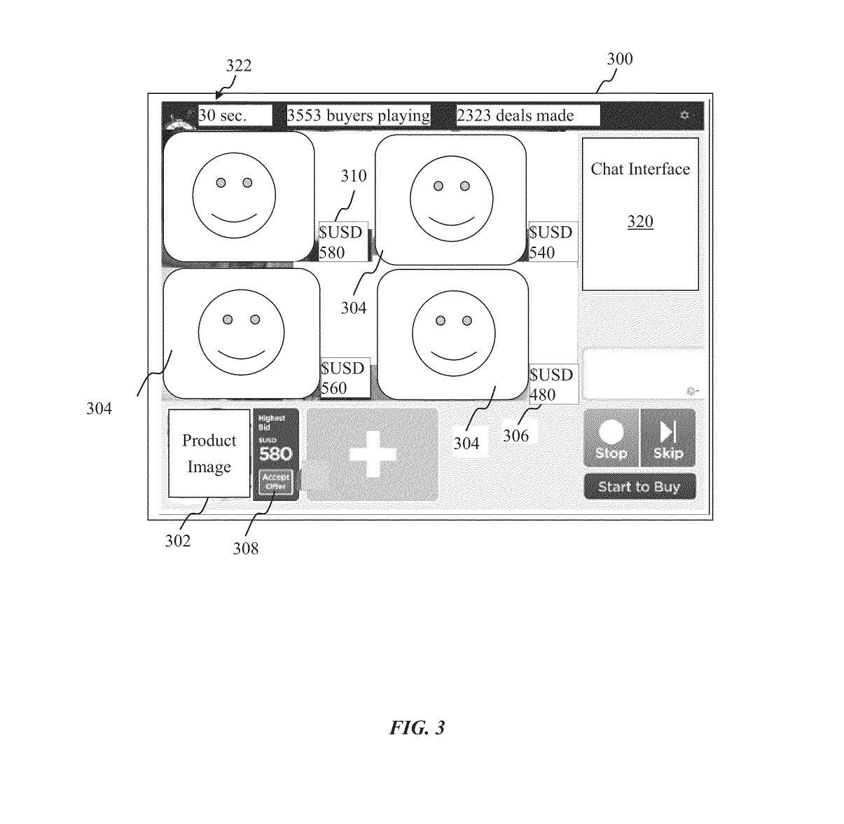

FIG. 3 illustrates a four-person auction interface 300 that can be presented to a seller. The seller may upload an image 302 of one or more items that the seller wishes to sell. Multiple bidders 304 may interact with the seller through a video or audio chat interface 320. The interaction may include a mechanism for the bidders 304 to submit competing bids 306 for one or more of the items being offered by the seller. The seller may accept a high bid for an item, ending the auction for that individual item, by selecting an “accept high-bid” button 308 in the interface. The bidder with the highest bid 310 for an item may be highlighted next to an image of the bidder.

A countdown timer 322 may be included in both the seller interface and each bidder interface, such that both the seller and the bidders are made aware of how much time is available to bid or ask questions about an item in an example, the seller may be able to extend the bidding time, thereby increasing the amount of time on the countdown timer 322. The seller may desire to extend the bidding time if bidding is heavy or if the bids are below a level, that is acceptable to the seller.

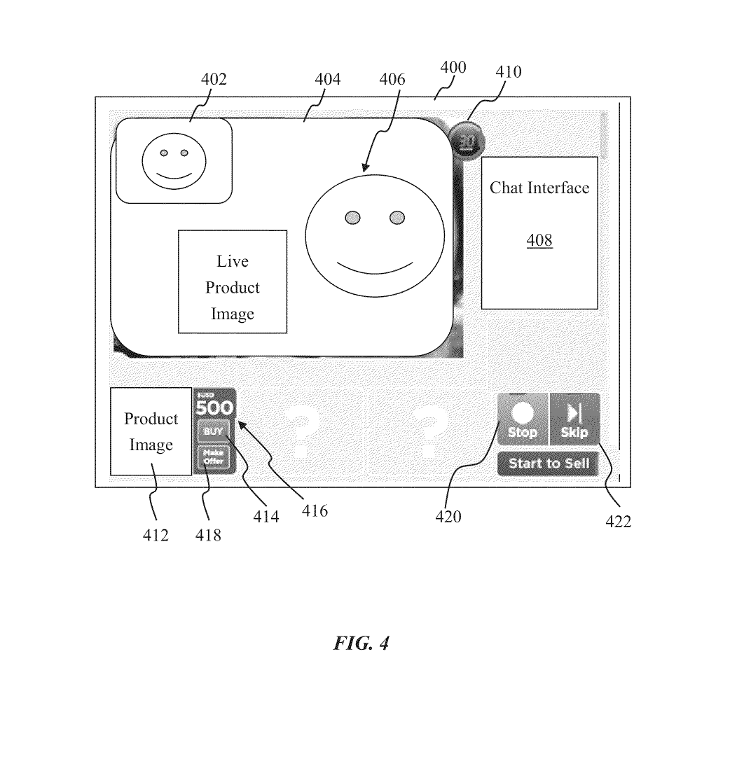

FIG. 4 illustrates an example buyer interface 400. Buyer interface 400 may include a frame that presents an image 402 of a user as captured by the user's camera coupled to a computer system that is coupled to a server configured to present the buyer interface 400. In an example, the image 402 may be an avatar representing the user, but not an actual photograph or live video of the user. The buyer interface 400 may also include a display area 404 that can present another user 406 (e.g., a seller) that the user is matched with. The other user 406 may be represented by a still picture, a video, or an avatar.

The users may communicate over a video link that may be established between the user's respective systems in a client-server-client or a peer-to-peer network. Communication may be conducted through audio or video, and also through the use of a chat interface 408 that may be used to exchange text communication.

A countdown timer 410 may provide an indication to the user as to the remaining duration of the connection and therefore the amount of time in which a deal may be consummated. An image of a product upon which the users may negotiate a price may be displayed in product frame 412. The buyer interface 400 may present a BUY option 414 that will allow a user to agree to purchase the item displayed in frame 412 for a price 416 set by the other user 406. The buyer interface 400 may present an OFFER option 418 that allows the user to present the other user 406 with a monetary offer to purchase the item displayed in product frame 412. If the other user accepts the price, the deal is complete, and a payment application may assist the user in completing the transaction.

At any time, the user may select a stop option 420 that is included in the buyer interface 400. The STOP option 420 allows the buyer to discontinue negotiations with the other user 406. A SKIP option 422 may also be presented in the buyer interface 400 that allows the user to indicate that they would like to view a similar product from a different potential seller.

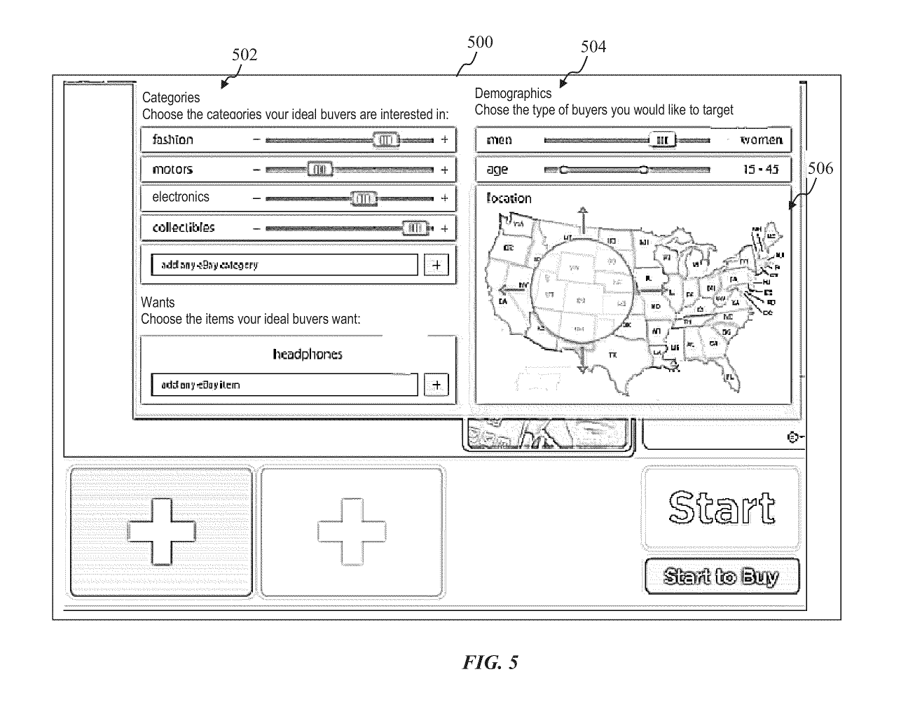

FIG. 5 illustrates an example targeting interface 500. The targeting interface can be utilized by buyers or sellers to enter preferences that may include categories of interest 502 (e.g., fashion, motors, electronics, collectibles, etc.), buyer wants or likes, seller inventory, specific demographics 504 (such as gender or age groups), geography 506, or other criteria.

Buyers and sellers may be matched based on the specified criteria of one or both of the buyers and sellers. In another example, buyers and sellers may be matched randomly. In another example, buyers and sellers may be matched based on the previous buying habits of one or more buyers and inventory being offered by one or more sellers.

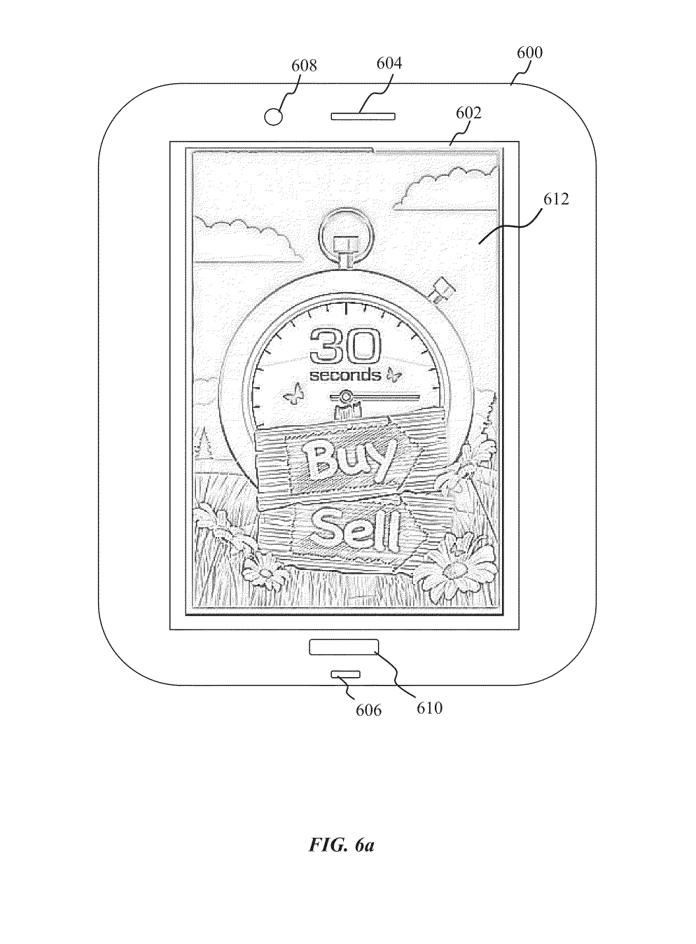

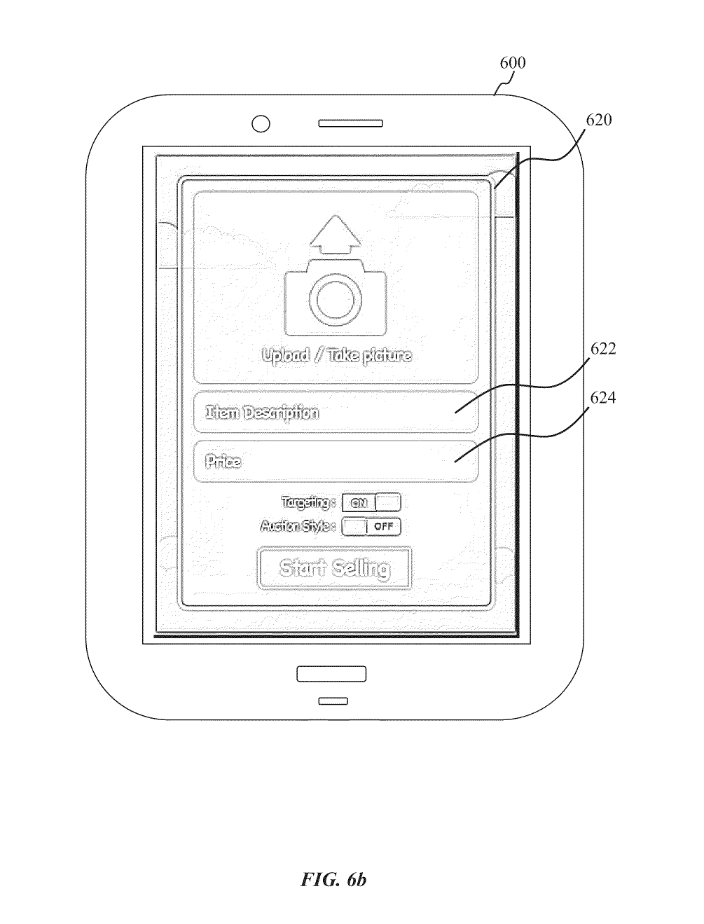

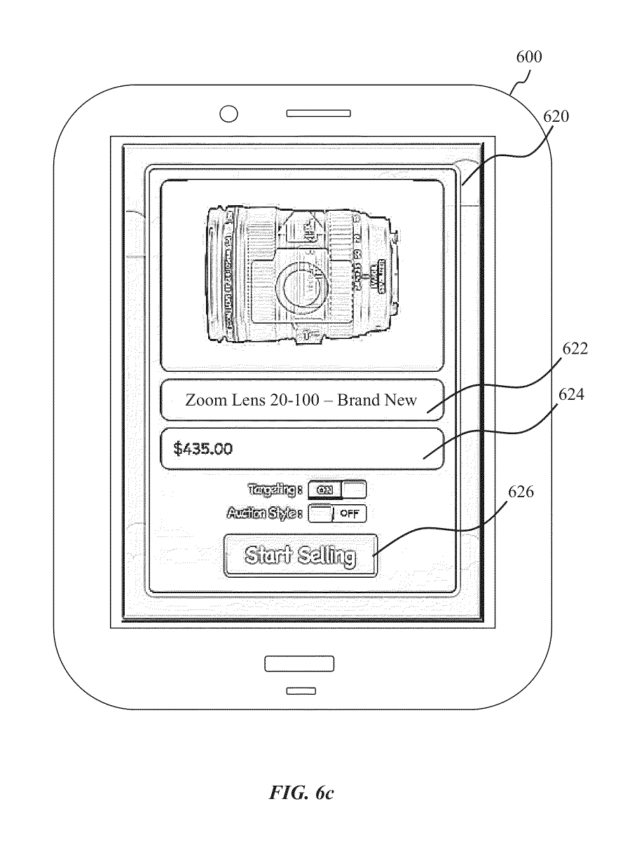

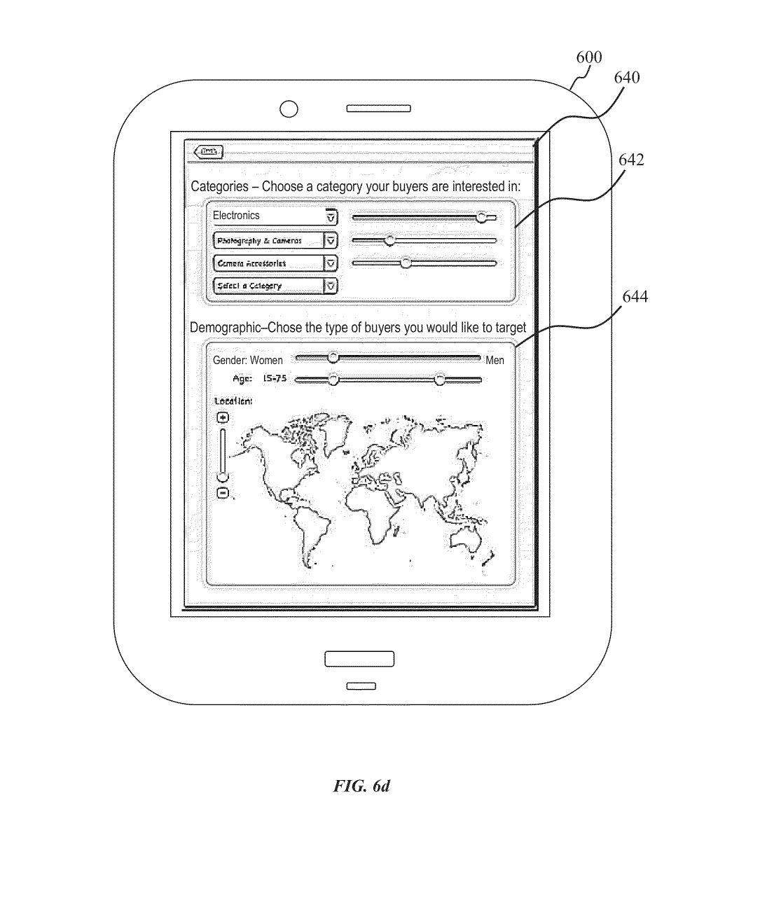

FIG. 6a below illustrates an example interface on a mobile device 600 configured with a live video based marketplace negotiation application. Mobile device 600 may include a cellular phone, a smart phone, a tablet computer, or any other network capable mobile computing device. Mobile device 600 includes a display 602, a speaker 604, a microphone 606, and at least one still or video camera 608. Mobile device 600 may include any number of interface buttons 610 and may include a touch screen interface integrated with display 602.

The application may include a graphical user interface 612 that provides a user with the option to either buy or sell a product in a limited time frame. In the example application depicted in FIG. 6a, a buyer and seller will have thirty seconds to agree to complete a transaction. Other time periods are also contemplated as discussed herein.

Upon selection of the buy option, the user will be presented with an interface to indicate what kind, type, or brand of product they are interested in purchasing. In an example embodiment, a user that selects the buy option may be randomly matched with an active seller. In an example embodiment, a user that selects the buy option will be matched with an active seller that is offering a product that the user has previously expressed interest in purchasing or is related to a previously completed purchase.

FIG. 6b illustrates an example seller interface 620 that may be presented on a mobile device 600 to a user who has selected the sell option of graphical user interface 612. Seller interface 620 provides a user with a mechanism to take and/or upload a picture of an article to sell. The mechanism may include an item description field 622 and a price field 624 where the user may describe and input an asking price thr the item, respectively.

FIG. 6c below illustrates an example of a seller interface 620 on mobile device 600 that has been completed by a user. Upon selection of the start selling button 626, the information entered in the description field 622 and price field 624 may be transmitted to a server to facilitate matching the seller with a potential buyer who may be interested in purchasing the described item.

FIG. 6d below illustrates an example of a mobile targeting interface 640 on mobile device 600 that provides the user with a categorization mechanism 642 to select or weight categories that may be related to, or descriptive of, the item for sale. The mobile targeting interface 640 may also include a demographic and geographic selection mechanism 644 that allows a user to target potential buyers by gender, age, geographic location, or other criteria.

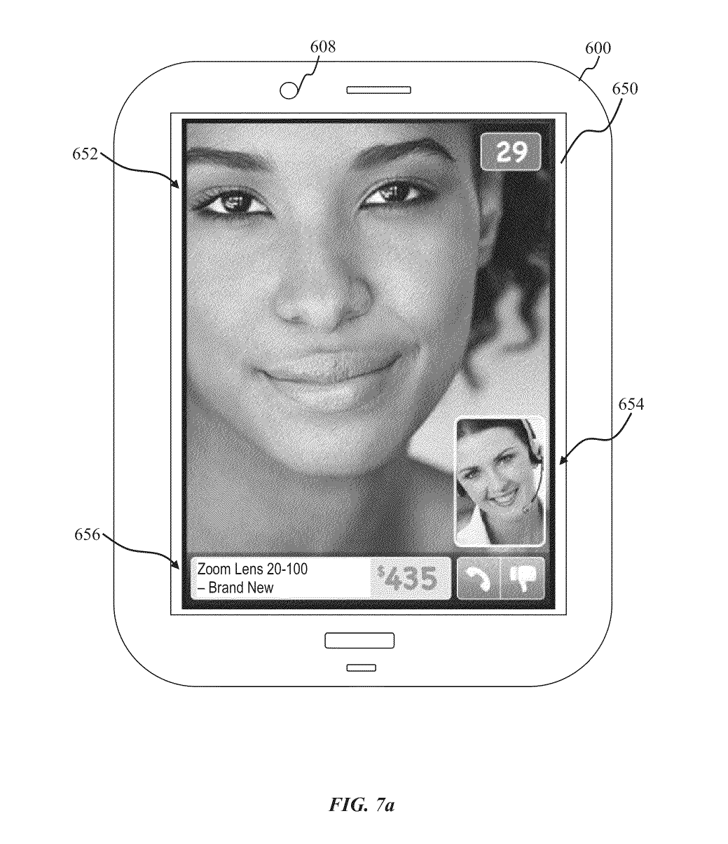

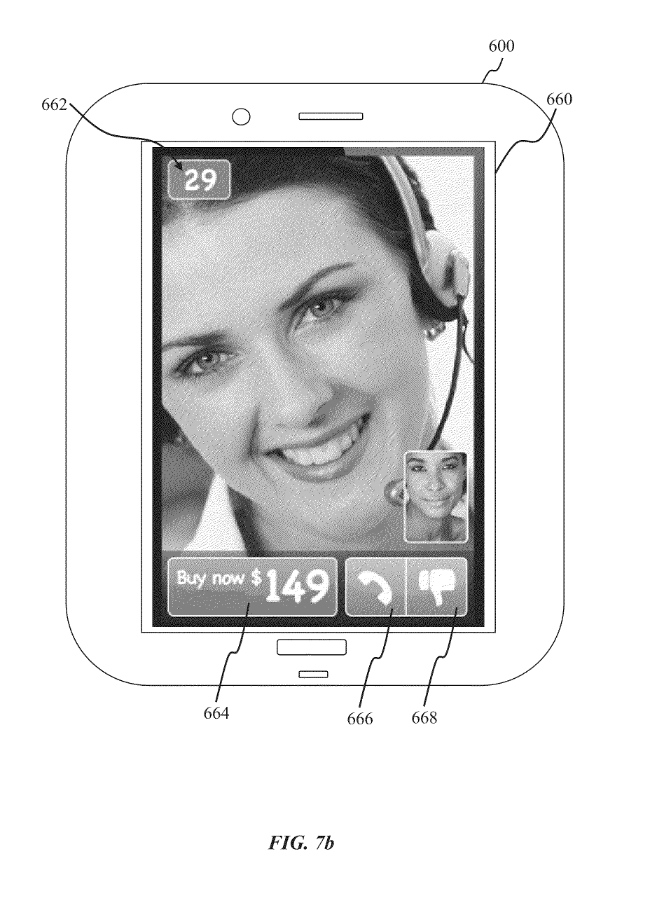

FIG. 7a illustrates an example seller video interface 650 on mobile device 600. The seller video interface 650 may include a live video image 652 of a potential buyer and a live seller video image 654 as captured by video camera 608. The seller video interface 650 may include a status display 656 including a description of the item for sale and an asking price.

FIG. 7b illustrates an example buyer video interface 660 on mobile device 600. The buyer video interface 660 may include both a live video image of the seller and the buyer. Both the seller video interface 650 and the buyer video interface 660 may include a countdown timer 662 that may indicate how much time remains before a transaction should be completed.

The buyer may select button 664 to agree to purchase an item offered by the seller. At any time, the buyer may terminate a negotiation with a seller by selecting a hang-up button 666 provided by the buyer video interface 660. Additionally, a buyer may request to be matched with a different seller by selecting a thumbs-down button 668 provided by the buyer video interface 660.

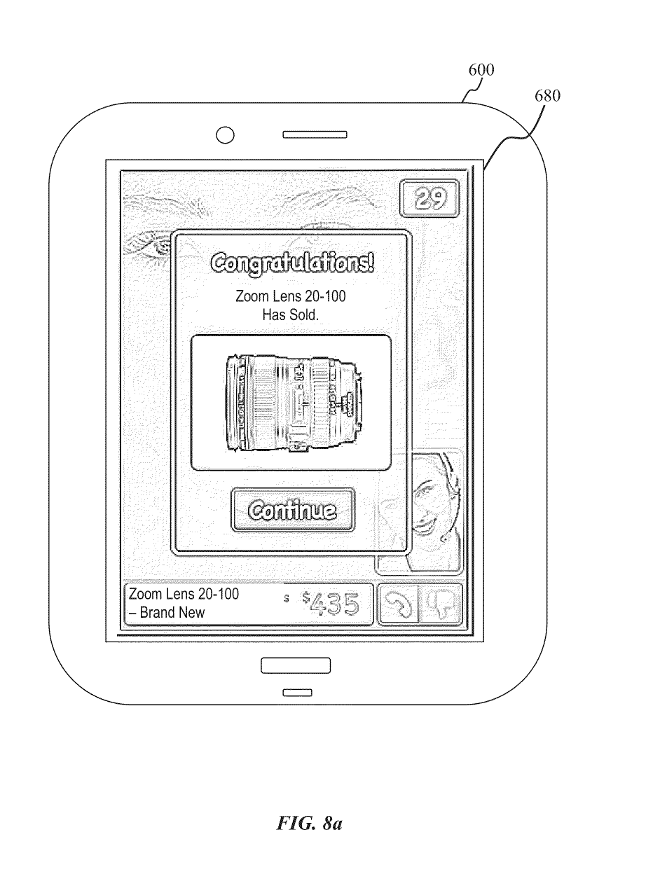

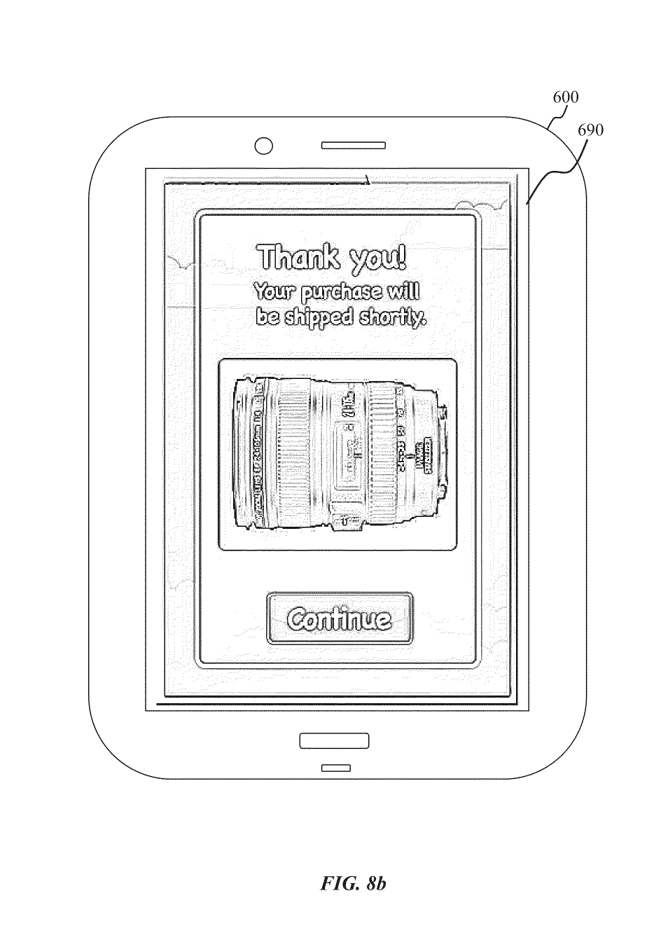

FIG. 8a illustrates an example transaction completion notification 680 that can be provided to a seller on the mobile device 600 after the buyer and seller agree to conduct a transaction at an agreed upon price.

FIG. 8b illustrates an example purchase notification 690 that can be provided to a buyer on the mobile device 600 after the buyer and seller agree to conduct a transaction at a mutually agreed upon price.

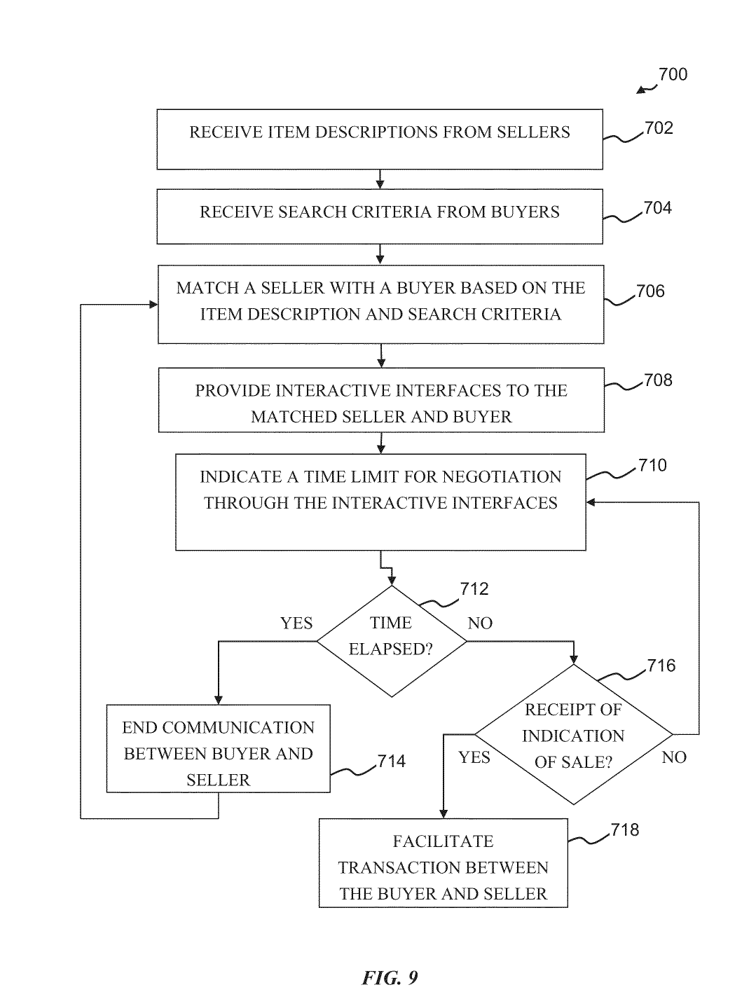

FIG. 9 illustrates an example scheme 700 for an interactive marketplace. At 702, item descriptions are received from sellers. Item descriptions may include textual, graphical, or video data depicting an item that an individual seller wishes to market. Item descriptions may include a desired price, a lower limit on the price, or any other information related to an item. At 704, search criteria are received from buyers. Search criteria may include a description of a specific item or service, or a general query for a category of goods.

At 706, at least one seller and at least one buyer are matched based on the item description provided by the at least one seller and the search criteria provided by the at least one buyer. At 708, an interactive interface, such as seller video interface 650 and buyer video interface 660 as depicted in FIGS. 7a and 7b, is provided to the matched at least one seller and at least one buyer. The interactive interface may provide an indication of a time limit for negotiation through the interactive interfaces, e.g., countdown timer 662 as depicted in FIG. 7b. The time limit for negotiation may be periodically updated, e.g., once a second, at 710. The time limit for negotiation may be received from either the buyer or the seller, or may be fixed by the interactive marketplace. Time limits may be limited to durations of less than a minute, e.g., thirty seconds, or longer than several minutes, e.g., five minutes. Other time limits may also be utilized in various embodiments, or in response to buyer or seller provided criteria.

At 712, a check is made to determine if the time limit for negotiation has elapsed. If the time limit has elapsed, then at 714 the communication between the buyer and seller is ended. The buyer and seller may be re-matched with different sellers or buyers, respectively, at 706. If the time limit has not elapsed, at 716 a check is made to determine if the buyer and seller have both provided an indication of a sale (e.g., a negotiated agreement where the buyer agrees to purchase an item from the seller at a mutually agreed upon price). If an indication of a sale is not received, then at 710, the time limit for negotiate may be updated. If an indication of a sale is received, then at 718, a transaction between the buyer and seller is facilitated. Transaction facilitation may include providing contact information, receipt and delivery of a monetary payment, shipping information, or any other assistance to complete the transaction between the buyer and seller.

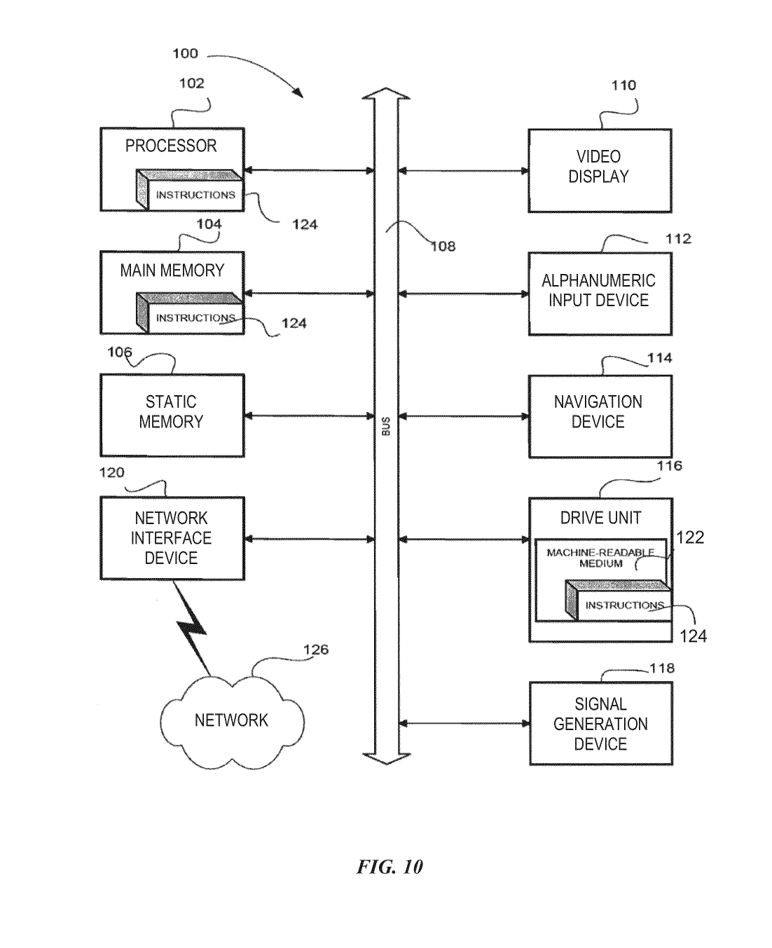

FIG. 10 shows a diagrammatic representation of machine in the example form of a computer system 100 within which a set of instructions, for causing the machine to perform any one or more of the methodologies discussed herein, may be executed. In alternative embodiments, the machine operates as a standalone device or may be connected (e.g., networked) to other machines, in a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a personal digital assistant (PDA), a cellular telephone, a portable music player (e.g., a portable hard drive audio device such as an MP3 player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 100 includes a processor 102 (e.g., a central processing unit (CPU), a graphics processing unit (GPU) or both), a main memory 104 and a static memory 106, which communicate with each other via a bus 108. The computer system 100 may further include a video display unit 110 (e.g., a liquid crystal display (LCD) or a cathode ray tube (CRT)). The computer system 100 also includes an alphanumeric input device 112 (e.g., a keyboard), a user interface (UI) navigation device 114 (e.g., a mouse), a disk drive unit 116, a signal generation device 118 (e.g., a speaker) and a network interface device 120.

The disk drive unit 116 includes a machine-readable medium 122 on which is stored one or more sets of instructions and data structures (e.g., software 124) embodying or utilized by any one or more of the methodologies or functions described herein. The software 124 may also reside, completely or at least partially, within the main memory 104 and/or within the processor 102 during execution thereof by the computer system 100, the main memory 104 and the processor 102 also constituting machine-readable media.

The software 124 may further be transmitted or received over a network 126 via the network interface device 120 utilizing any one of a number of well-known transfer protocols (e.g., HTTP, FTP, etc.).

While the machine-readable medium 122 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention, or that is capable of storing, encoding or carrying data structures utilized by or associated with such a set of instructions. The term “machine-readable medium” shall accordingly be taken to include, but not be limited to, solid-state memories, optical and magnetic media, and carrier wave signals. Such medium may also include, without limitation, hard disks, floppy disks, flash memory cards, digital video disks, random access memory (RAM), read only memory (ROM), and the like.

The embodiments described herein may be implemented in an operating environment comprising software installed on a computer, in hardware, or in a combination of software and hardware.

Although embodiments have been described with reference to specific example embodiments, it will be evident that various modifications and changes may be made to these embodiments without departing from the broader spirit and scope of this document. Accordingly, the specification and drawings are to be regarded in an illustrative rather than a restrictive sense.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., Application Program Interfaces (APIs).)

1. A computerized method of providing an interaction over a network comprising:
receiving information from a first client, over a computer network, the information including an item description;
receiving data from a second client, over a computer network, the data including a search criteria;
matching the first client with the second client based on the received information and data;
providing an interactive interface to the matched first client and the second client, the interactive interface including audio, video, or both;
limiting communication through the interactive interface between the matched first client and second client to a predetermined time period; and
facilitating, via interactive interface substantially simultaneously, a negotiation between the first client and the second client for the sale of an item in the item description.

2. The method of claim 1, comprising: providing to the first client, via the interactive interface, an option to end communication with the second client and receive a second match with another client.

3. The method of claim 1, comprising: providing second client, via the interactive interface, an option to end communication with the first client and receive a second match with another client.

4. The method of claim 1, further comprising completing a transaction according to terms negotiated between the first client and the second client for the item.

5. The method of claim 1, wherein the receiving information from the first client includes receiving the predetermined time period.

6. The method of claim 1, wherein the limiting communication includes interrupting the interactive interface at the predetermined time period.

7. The method of claim 6, wherein the predetermined time period is less than five minutes.

8. The method of claim 1, wherein receiving information from the first client includes a fixed number of items, a description of the items, and a price associated with each item.

9. The method of claim 1, wherein facilitating the transaction between the matched first client and the second client is performed in response to receipt of an indication from both the first client and the second client, wherein the indication includes an agreed upon price.

10. A tangible computer readable medium comprising a plurality of instructions that in response to being executed on a computing device, cause the computing device to:
provide a sales interface to a plurality of sellers, the sales interface including a video link and a mechanism to list a fixed number of products for sale;
provide a shopping interface to a plurality of buyers, the shopping interface including a video link and an input mechanism to receive information including a desired purchase;
match at least one buyer and at least one seller from the plurality of buyers and the plurality of sellers based on a criteria, the criteria including the desired purchase and the products for sale;
connect, over a network, the video link of the at least one buyer and the video link of the at least one seller for a limited period of time; and
facilitate, via the video links of sales interface and shopping interface substantially simultaneously, a negotiation between the at least one buyer and the at least one seller may negotiate tier the sale of one or more of the at least one seller's products for sale.

11. The tangible computer readable medium of claim 10, further comprising completing a transaction according to terms negotiated between the at least one buyer and the at least one seller for the purchase of at least one of the seller's products for sale.

12. The tangible computer readable medium of claim 10, the sales interface including an indication of the limited period of time to the at least one seller.

13. The tangible computer readable medium of claim 12, comprising: providing the seller an option, via the interactive interface, to end communication with the matched buyer and receive a second match with another of the at least one of the plurality of buyers.

14. The tangible computer readable medium of claim 10, the shopping interface including an indication of the limited period of time to the at least one buyer.

15. The tangible computer readable medium of claim 14, comprising: ending the video link between the at least one buyer and the at least one seller when the limited period of time has elapsed.

16. The tangible computer readable medium of claim 10, comprising: providing the buyer an option, via the interactive interface, to end communication with the matched seller and receive a second match with another of the at least one of the plurality of sellers.

17. A system for facilitating market interactions over a network comprising:
a server including one or more processors, the processors configured to provide:
a market interface including: a seller interface configured to receive connections via the network from a plurality of sellers such that each of a plurality of sellers can offer a fixed number of items for sale, and a buyer interface configured to receive connections via the network from a plurality of buyers such that each of the plurality of buyers may enter a criteria, the criteria including the desired purchase and the products for sale;
a interactive negotiation interface configured match at least one buyer and at least one seller based on the items for sale and the criteria, and connect, over the network, one of the plurality of sellers and one of the plurality of buyers via the video link of the at least one buyer and the video link of the at least one seller for a limited period of time; and
a transaction interface configured to facilitate for a limited period of time, via the video link and the market interface substantially simultaneously, negotiations between the at least one buyer and the at least one seller may negotiate for the sale of one or more of the at least one seller's products for sale.

18. The system of claim 17, wherein the transaction interface is further configured to facilitate a transaction according to terms negotiated between the at least one buyer and the at least one seller for the purchase of at least one of the seller's products for sale.

19. The system of claim 17, the seller interface including an indication of the limited period of time to the at least one seller, and the buyer interface including an indication of the limited period of time to the at least one buyer.

20. The system of claim 19, wherein the limited period of time is more than twenty seconds and less than ninety seconds, and the fixed number of items thr sale is less than ten.
